(19) United States
(12) Patent Application Publication
(10) Pub. No.: US 2011/0206243 A1
(43) Pub. Date: Aug. 25, 2011

(54) MULTI-BIOMETRIC IDENTIFICATION SYSTEM

(75) Inventor: Steven E. Vlcan, Alexandria, VA (US)

(73) Assignee: Unisys Corp., Blue Bell, PA (US)

(21) Appl. No.: 12/887,526

(22) Filed: Sep. 22, 2010

Related U.S. Application Data
(60) Provisional application No. 61/244,446, filed on Sep. 22, 2009.

(51) Int. Cl. G06K 9/00

(52) U.S. Cl. 382/117

(57) ABSTRACT

An identification system for authenticating individuals may include enrolling an individual's iris images into a database for late comparison during an identification process. A security attendant may enroll the individual with a mobile device having an iris camera, which captures the individual's iris images. The attendant may also insert biographical information and a face image of the individual. When the individual may be authenticating by walking through a pedestrian lane having an iris camera identification system. The system captures the individual's iris images and compares them to previously enrolled iris images. A nearby security attendant may be alerted to individuals proceeding through a pedestrian lane who have not been previously enrolled.

### CROSS-REFERENCE TO RELATED APPLICATIONS

This application claims the benefit of U.S. Provisional Patent Application No. 61/244,446 entitled “Multi-Biometric System and Methods” to Steven Vlcan, filed Sep. 22, 2009.

### TECHNICAL FIELD

The instant disclosure relates to an identification system. More specifically, the disclosure relates to systems and methods for identification of users based on a biometric identifier, such as an iris image.

### BACKGROUND

Identifying and authenticating individuals is conventionally performed with photographic identification documents such as, for example, passports and state-issued driver licenses. When authenticating an individual with a paper document, the individual's identity may be falsely identified if the paper documents are forged. This allows access to restricted resources not intended for use by the individual. Although security measures may be built in to the paper documents when issued by appropriate authorities, the security measures can often be circumvented.

One conventional method for identifying and authenticating individuals having reduced likelihood of forgery is fingerprinting. Fingerprints are physical human features, which are more difficult to forge. Thus, the identity of the individual authenticated through a fingerprint has a higher likelihood of being a true and accurate identity for that individual. Although fingerprints may improve security, requiring individuals to stop and contact one or several of their fingers to a scanner may reduce the throughput of a security screening processing relying on fingerprints to identify individuals.

Identification and authentication using fingerprints or paper documents may be too slow when large numbers of individuals are waiting for identification. The slow nature of the fingerprint and paper document authentication methods may be attributed to the physical contact between the individual and an attendant or between the individual and a fingerprint scanner. In certain scenarios, such as at a border crossing where individuals are authenticated before gaining entry to a country, fingerprint and paper document authentication methods may be undesirably slow and add to the frustration of the individuals waiting to be authenticated.

### SUMMARY

According to one embodiment, a method includes capturing at least one enrollment iris image of an individual with an iris camera. The method also includes enrolling the individual in an identification system. The method further includes capturing at least one identification iris image of the individual with the iris scanner. The method also includes identifying the individual by comparing the at least one identification iris image with the at least one enrollment iris image in the identification system.

According to another embodiment, a computer program product includes a computer-readable medium having code to receive at least one enrollment iris image for an individual. The medium also includes code to enroll an individual by storing the at least one enrollment iris image in an identification database having a plurality of stored iris images. The medium further includes code to receive an identification iris image from an iris scanner. The medium also includes code to compare the identification iris image to the plurality of stored iris images. The medium further includes code to display an authorized user message to an attendant when the identification iris image matches one of the plurality of stored iris images. The medium also includes code to display a failed authentication message to an attendant when the identification iris image does not match at least one of the plurality of stored iris images.

According to yet another embodiment, an apparatus includes a processor and a memory device coupled to the processor, in which the processor is configured to receive at least one enrollment iris image for an individual. The processor is further configured to enroll an individual by storing the at least one enrollment iris image in an identification database having a plurality of stored iris images. The processor is also configured to receive an identification iris image from an iris scanner. The processor is further configured to compare the identification iris image to the plurality of stored iris images. The processor is also configured to display an authorized user message to an attendant when the identification iris image matches one of the plurality of stored iris images. The processor is further configured to display a failed authentication message to an attendant when the identification iris image does not match at least one of the plurality of stored iris images.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a system for collecting and/or storing identification information according to one embodiment of the disclosure.

FIG. 2 is block diagram illustrating a data management system configured to store identification information according to one embodiment of the disclosure.

FIG. 3 is a block diagram illustrating a computer system for collecting and/or storing identification information according to one embodiment of the disclosure.

FIG. 4 is a flow chart illustrating a method for authentication according to one embodiment of the disclosure.

FIG. 5 is a block diagram illustrating a system of software components of an identification system according to one embodiment of the disclosure.

FIG. 6 is a block diagram illustrating a relational database for storing identification information according to one embodiment of the disclosure.

FIG. 7 is a call flow diagram illustrating enrollment of an enrollee through a mobile device according to one embodiment of the disclosure.

FIG. 8A is an overhead view for a pedestrian lane in a walk-through configuration according to one embodiment of the disclosure.

FIG. 8B is an overhead view for a pedestrian lane in a stop-and-go configuration according to one embodiment of the disclosure.

FIG. 9 is a call flow diagram illustrating enrollment of an enrollee through a pedestrian lane according to one embodiment of the disclosure.

FIG. 10 is a call diagram illustrating identification of an individual with an identification system according to one embodiment of the disclosure.

### DETAILED DESCRIPTION

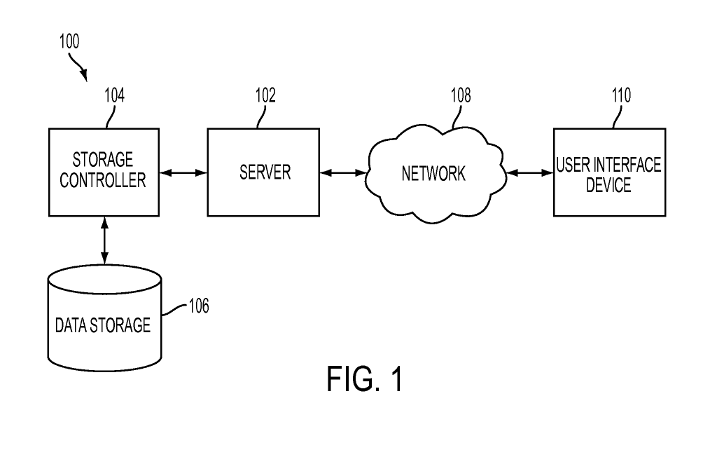

FIG. 1 illustrates one embodiment of a system 100 for collecting and/or storing identification information. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a personal digital assistant (PDA) or tablet computer, a smartphone or other a mobile communication device or organizer device having access to the network 108. In a further embodiment, the user interface device 110 may access the Internet or other wide area or local area network to access a web application or web service hosted by the server 102 and provide a user interface for enabling a user to enter or receive information. For example, the user may enter an individual's information and iris image into the system 100.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the server 102 is configured to store enrolled iris images and/or biographical data. Additionally, the server may access data stored in the data storage device 106 via a Storage Area Network (SAN) connection, a LAN, a data bus, or the like.

The data storage device 106 may include a hard disk, including hard disks arranged in an Redundant Array of Independent Disks (RAID) array, a tape storage drive comprising a magnetic tape data storage device, an optical storage device, or the like. In one embodiment, the data storage device 106 may store identification images. The data may be arranged in a database and accessible through Structured Query Language (SQL) queries, or other data base query languages or operations.

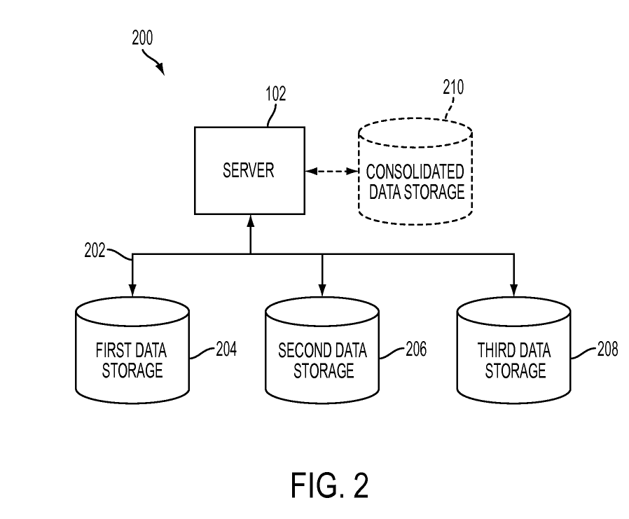

FIG. 2 illustrates one embodiment of a data management system 200 configured to store identification information. In one embodiment, the data management system 200 may include a server 102. The server 102 may be coupled to a data-bus 202. In one embodiment, the data management system 200 may also include a first data storage device 204, a second data storage device 206, and/or a third data storage device 208. In further embodiments, the data management system 200 may include additional data storage devices (not shown). In such an embodiment, each data storage device 204, 206, 208 may each host a separate database that may, in conjunction with the other databases, contain redundant data. Alternatively, the storage devices 204, 206, 208 may be arranged in a RAID configuration for storing a database or databases through may contain redundant data.

In one embodiment, the server 102 may submit a query to selected data storage devices 204, 206 to match captured iris images with stored iris images for locating an individual's identification information. The server 102 may store the consolidated data set in a consolidated data storage device 210. In such an embodiment, the server 102 may refer back to the consolidated data storage device 210 to obtain a set of data elements associated with a specified individual's identification. Alternatively, the server 102 may query each of the data storage devices 204, 206, 208 independently or in a distributed query to obtain the set of data elements associated with an individual's identification. In another alternative embodiment, multiple databases may be stored on a single consolidated data storage device 210.

The data management system 200 may also include files for entering and processing individual's identification information and iris images. In various embodiments, the server 102 may communicate with the data storage devices 204, 206, 208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 102 may communicate indirectly with the data storage devices 204, 206, 208, 210; the server 102 first communicating with a storage server or the storage controller 104.

The server 102 may host a software application configured for generating, storing, and/or obtaining identification information for an individual. The software application may further include modules for interfacing with the data storage devices 204, 206, 208, 210, interfacing a network 108, interfacing with a user through the user interface device 110, and the like. In a further embodiment, the server 102 may host an engine, application plug-in, or application programming interface (API).

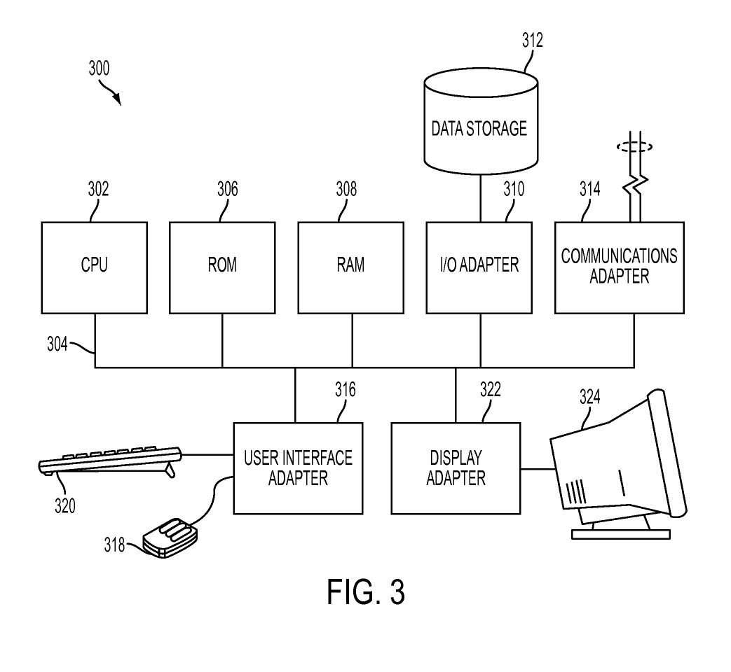

FIG. 3 illustrates a computer system 300 adapted according to certain embodiments of the server 102 and/or the user interface device 110. The central processing unit (“CPU”) 302 is coupled to the system bus 304. The CPU 302 may be a general purpose CPU or microprocessor, graphics processing unit (“GPU”), microcontroller, or the like. The present embodiments are not restricted by the architecture of the CPU 302 so long as the CPU 302, whether directly or indirectly, supports the modules and operations as described herein. The CPU 302 may execute the various logical instructions according to the present embodiments.

The computer system 300 also may include random access memory (RAM) 308, which may be SRAM, DRAM, SDRAM, or the like. The computer system 300 may utilize RAM 308 to store the various data structures used by a software application having code to enroll individuals in an identification system. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300 in order to input identification information. In a further embodiment, the display adapter 322 may display a graphical user interface associated with a software or web-based application for generating, storing, and/or authenticating identification information.

The I/O adapter 310 may connect one or more storage devices 312, such as one or more of a hard drive, a compact disk (CD) drive, a floppy disk drive, and a tape drive, to the computer system 300. The communications adapter 314 may be adapted to couple the computer system 300 to the network 108, which may be one or more of a LAN, WAN, and/or the Internet. The user interface adapter 316 couples user input devices, such as a keyboard 320 and a pointing device 318, to the computer system 300. The display adapter 322 may be driven by the CPU 302 to control the display on the display device 324.

The applications of the present disclosure are not limited to the architecture of computer system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

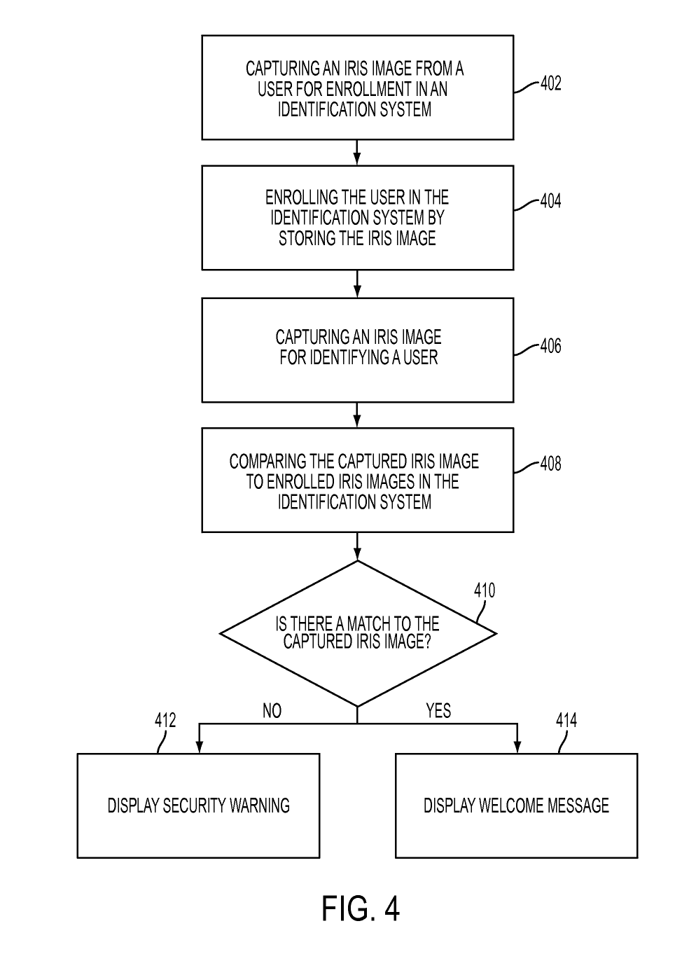

FIG. 4 is a flow chart illustrating a method for authentication according to one embodiment of the disclosure. At block 402 an iris image may be captured from an individual for enrollment in an identification system. At block 404 the individual may be enrolled in the identification system by storing the individual iris image. Additionally, other identification information such as, for example, a face image, name, and address information may included with the iris image. The capturing and enrolling of blocks 402, 404 may be performed by an attendant with a mobile iris camera and identification entry device. At block 406, an iris image may be captured for identifying an individual. For example, when an individual is entering a country, their iris image may be captured. At block 408 the captured iris image may be compared to iris images enrolled in the identification system. At block 410 an identification system may determine if the captured iris image matches any of the enrolled iris images. If a match is found a welcome message and/or other instructions may be presented to the individual or a nearby attendant at block 414. If no match is found a security warning may be presented to the individual or a nearby attendant at block 412.

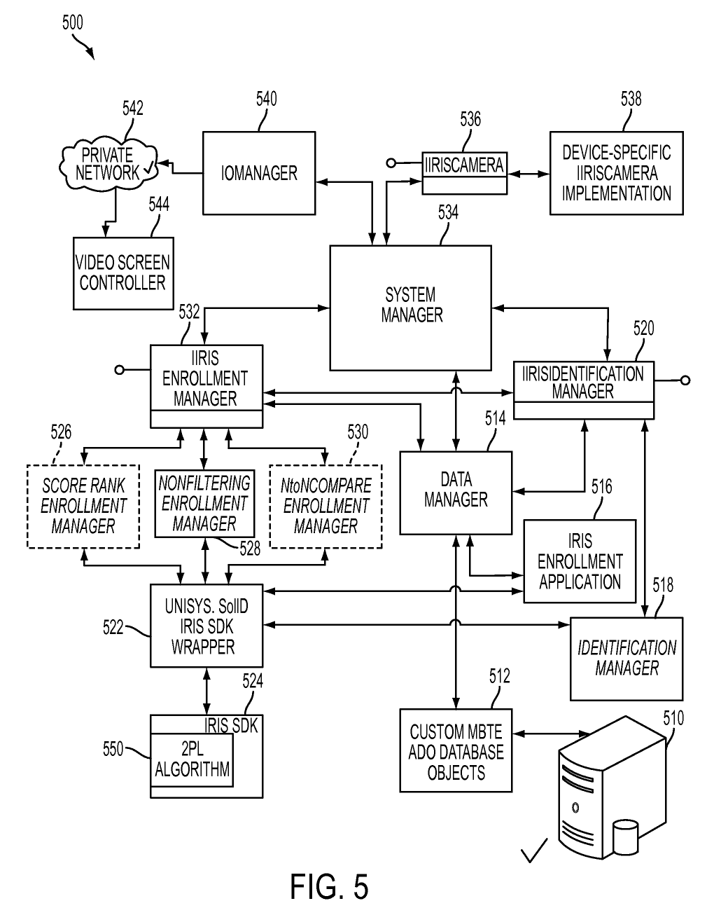

An identification system for authenticating individuals with iris images may be implemented on a server in one or more software components. FIG. 5 is a block diagram illustrating a system of software components of an identification system according to one embodiment of the disclosure. A system 500 includes a system manager 534 for directing interactions between other components of the system 500. For example, the system manager 534 may cause an iris template generation event in response to an iris image capture event occurring in the system 500.

An IIrisCamera interface 536 couples to the system manager 534 and may provide an interface for enrolling and/or identifying users, receiving iris images, and/or receiving face images. The IIrisCamera interface 536 may be programmed using frameworks such as the .NET 2.0 Framework. The IIrisCamera interface 536 couples to a device-specific IIrisCamera implementation 538. The device-specific implementation 538 may communicate with the IIrisCamera interface 536 through iris device objects implementing the IIrisCamera interface 536. For example, a vendor of the device-specific implementation 538 may have a software development kit (SDK) for communicating with the iris device objects. Although not shown, additional interfaces may be provided in a similar fashion to devices such as document capture devices, and fingerprint capture devices, and cameras.

An input/output (IO) manager 540 may couple the system manager 534 to a private network 542. The IOManager 540 may be designed for a specific private network 542 or for general networks. For example, the IOManager 540 may interface the system manager 534 with an Ethernet port for coupling to a video screen controller 544. Although not shown, additional IO managers may be present for communicating with other networks such as cellular networks and wireless data networks. The video screen controller 544 may control one or more video screens for displaying messages and/or warnings to security attendants or individuals identified by the system 500. For example, the video screen controller 544 may be coupled to a liquid crystal display (LCD) screen (not shown) and/or light emitting diode (LED) lights (not shown). According to one embodiment, the video screen controller 544 accepts messages for display on displays through network protocols such as transmission control protocol/internet protocol (TCP/IP) or hypertext transfer protocol (HTTP) from the private network 542.

An IIris enrollment manager 532 may couple to the system manager 534 to provide an interface for supporting enrollment manager functions. The IIris enrollment manager 532 may be coupled to one or more of a score rank enrollment manger 526, a non-filtering enrollment manager 528, and an N-to-N enrollment manager 530. The interface of the IIris enrollment manager 532 to the managers 526, 528, 530 allows flexibility when adding managers or modifying the managers 526, 528, 530 to change enrollment behavior. The non-filtering enrollment manager 528 generates enrollment templates for each iris image received from an iris camera (not shown). The N-to-N enrollment manager 530 filters iris images received from an iris camera by calculating a hamming distance for each pair of enrollment iris images, where a pair includes one iris image for each of an individual's eyes. The number of hamming distance calculations performed (c_{HD}) is proportional to n, the number of iris images for an individual according to the following equation:

$$\text{?} = \frac{\text{?} - \text{?}}{2}$$

$$\text{?} \text{indicates text missing or illegible when filed}$$

For example, if ten iris images are returned for the right iris of an individual, 45 hamming distance calculations are performed. The pair of iris images for the right iris and the left iris of an individual having the lowest hamming distance are selected by the N-to-N enrollment manager 530 for storing in an identification database. The score rank enrollment manager 526 ranks iris images captured from an iris camera. After ranking the iris images, the score rank enrollment manager 526 may select only a pair of iris images for storing in an identification database.

An Iris SDK 524 is coupled to the managers 526, 528, 530 through an Iris SDK wrapper 522. The Iris SDK 524 may include a number of objects including an object for supporting an iris camera device (not shown), an object for supporting iris images and manipulation of iris images, and/or an object for conversion of iris images into ISO/IEC standard formats. The Iris SDK wrapper 522 provides an interface between operating system application and libraries and the Iris SDK 524. The interface may include defined constants, structures, and/or functions programmed as .NET 2.0 Framework objects. The Iris SDK 524 may include a 2 pi algorithm 550.

A data manager 514 is coupled to the system manager 534 for handling database transactions. According to one embodiment, operations performed by the database manager 514 may include no reference to specific database tables or database products on a server 510 to simplify adapting the system 500 to changes in the underlying structure of an identification database. The data manager 514 may be coupled to custom MBTE ADO database objects 512. The database objects 512 may be automatically generated based on defined database structures in the identification database stored on the server 510. The data manager 514 may also be coupled to an iris enrollment application 516. The enrollment application 516 may receive enrollment information from an attendant about individuals for enrollment in the identification database. The enrollment application 516 may execute on a processor-based device separate from other modules of the system 500. According to one embodiment, the enrollment application 516 executes on a mobile device operated by an attendant.

An IIris identification manager 520 may be coupled to the system manager 534. The identification manager 520 may perform functions for managing identification information in an identification database. For example, the identification manager 520 may select all or a subset of enrollment records that determine the pool from which an identification match will be made. As another example, the identification manager 520 may perform matching between submitted identification images from an identification session and an enrollment record pool. In yet another example, the identification manager 520 may return a set of matching enrollment records. The identification manager 520 may be coupled to an identification manager 518, which matches identification images and enrollment records. For example, the identification manager 520 may support filtering enrollment records.

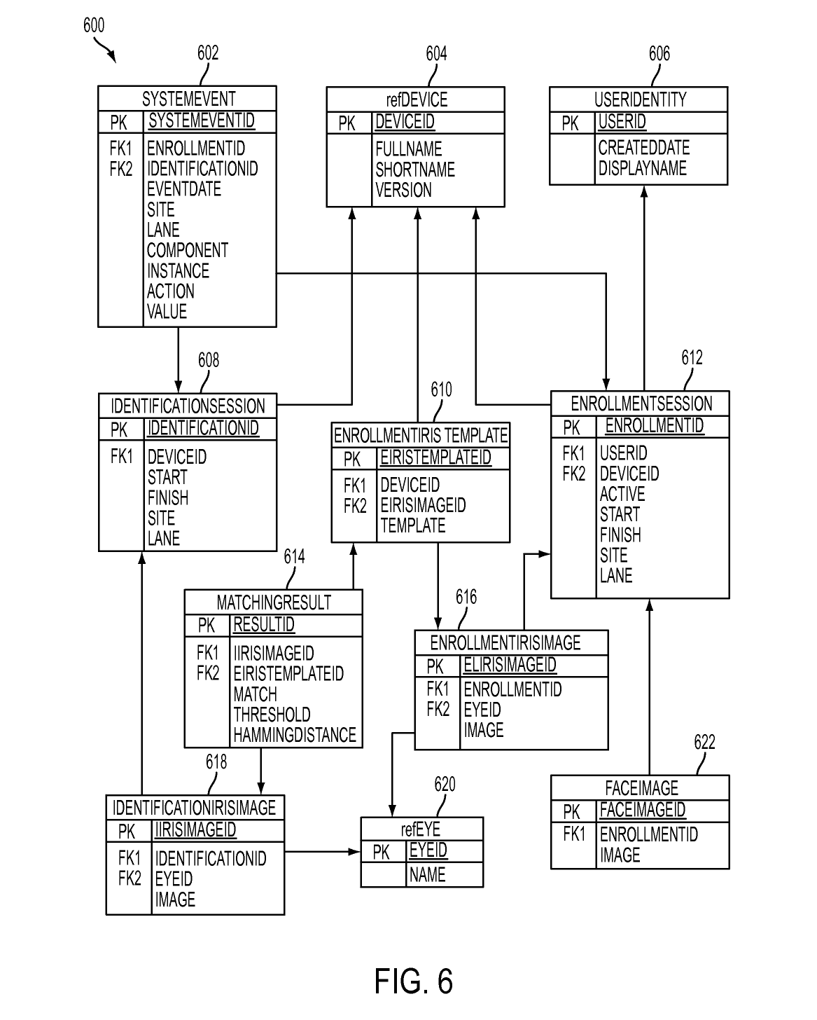

Information collected through the system 500 may be stored in a relational database on a data management system, such as the data management system of FIG. 2. FIG. 6 is a block diagram illustrating a relational database for storing identification information according to one embodiment of the disclosure. A relational database 600 includes tables coupled through ID fields. According to one embodiment, the relational database 600 is stored in a SQL database server. The database 600 includes a table 602 for recording events occurring in an identification system. For example, changing of displays or flow-control lights in a pedestrian travel lane may be recorded in the table 602. A recorded event may include information stored in an EventDate, Site, Lane, Component, Instance, Action, and/or Value field of the table 602. Additionally, events stored in the table 602 may be correlated with an enrollment session or an identification session by an EnrollmentID field and an IdentificationID field, respectively. Each event logged in the table 602 may be assigned a unique SystemEventID.

A table 608 of the database 600 captures session data from each identification attempt. The table 608 may include information stored in a DeviceID, Start, Finish, Site, and/or Lane field. Each identification session in the table 608 may be assigned a unique IdentificationID. The table 608 may be correlated with devices through the Device ID field. Information about devices in an identification system may be stored in a table 604.

The table 604 may include information stored in a FullName, ShortName, and/or Version field. For example, the table 604 may include an entry for each iris image scanner, fingerprint scanner, and/or mobile enrollment device in an identification system. According to one embodiment, the contents of the table 604 may be static data, which is rarely modified.

A table 618 captures iris images collected during identification attempts in the identification system. Each time an individual is authenticated or requests identification an iris image may be captured and stored in the table 618. The table 618 may include information stored in an IdentificationID, EyeID, and/or Image field. According to one embodiment, the Image field may store raw ISO standard rectilinear images. Each entry in the table 618 may have a unique IIrisImageID number. The IdentificationID field may be correlated to an identification session of the table 608. The eyeID field may be correlated to a table 620.

The table 620 may store references for enumerating possible designations of an iris image captured by an iris camera. The table 620 may include a Name field for storing enumerations such as “LEFT,” “RIGHT,” and/or “UNKNOWN.” When an iris image is captured and stored in the table 618 the entry in table 618 may have an EyeID field specifying if the captured iris image is from an individual's left eye, right eye, or unknown.

A table 614 may store matching calculations performed during an identification session. Each entry in the table 614 may have a unique ResultID number. The table 614 may store information about a matching result in an IIrisImageID, ElrisTemplateID, Match, Threshold, and/or HammingDistance field. The table 614 may be correlated to the table 618 and a table 610 through the IIrisImageID and the ElrisTemplateID fields, respectively. According to one embodiment, each entry in the table 614 includes a record of the identification image and the enrollment template compared during a matching process, a record of the match result (e.g., true or false), a record of a threshold for the matching, and a record of the computed hamming distance. Queries to the database 600 and the table 614 may allow recreation of an identification session having a match list and candidate list.

When an individual is enrolled in an identification system, the individual's iris images may be captured and stored in a table 616. The table 616 may include information stored in an EnrollmentID, EyeID, and/or Image field. Each entry in the table 616 may be identified by a unique ElrisImageID field. The table 616 may be correlated to the table 620 and the table 612 through the EyeID field and the EnrollmentID field, respectively. According to one embodiment, when multiple iris images are captured for an individual, only a selection of the enrollment images are stored in the table 616. For example, when ten images of each eye are captured, only the best two iris images per eye may be stored in the table 616.

A table 610 may store templates generated from iris images of the table 616. The table 616 may include information in a DeviceID, ElrisImageID, and/or Template field. The table 616 may be correlated with the tables 616, 604 through the ElrisImageID field and the DeviceID field, respectively. Each entry in the table 610 may have a unique ElrisTemplateID number.

According to one embodiment, a face image may be captured along with an iris image. When face images are captured, the face images may be stored in a table 622. The table 622 may include information stored in an EnrollmentID and/or Image field. Each entry in the table 622 may have a unique FaceImageID number and be correlated with an entry of a table 612 through an EnrollmentID field. The table 612 may capture information about enrollment attempts. The table 612 may store information in a UserID, DeviceID, Active, Start, Finish, Site, and/or Lane field. Each entry in the table 612 may have a unique EnrollmentID number and be correlated with the a table 606 and the table 604 through a UserID and a DeviceID fields, respectively. According to one embodiment, the active field may mark a single active enrollment for a user and device combination. Thus, when a user may be marked inactive to prevent identification by the identification system without deleting the user's information.

The table 606 stores enrolled users of the identification system. The table 606 may include a CreatedDate and/or a DisplayName field, and each entry of the table 606 may have a unique UserID. Privacy may be preserved by identifying enrolled users of the identification system by only a database-issued UserID number. According to one embodiment, additional information such as, for example, height, weight, eye color, ethnic, and/or biographic data may be stored in the table 606 or in a separate table (not shown) and linked through a correlated field in the table 606.

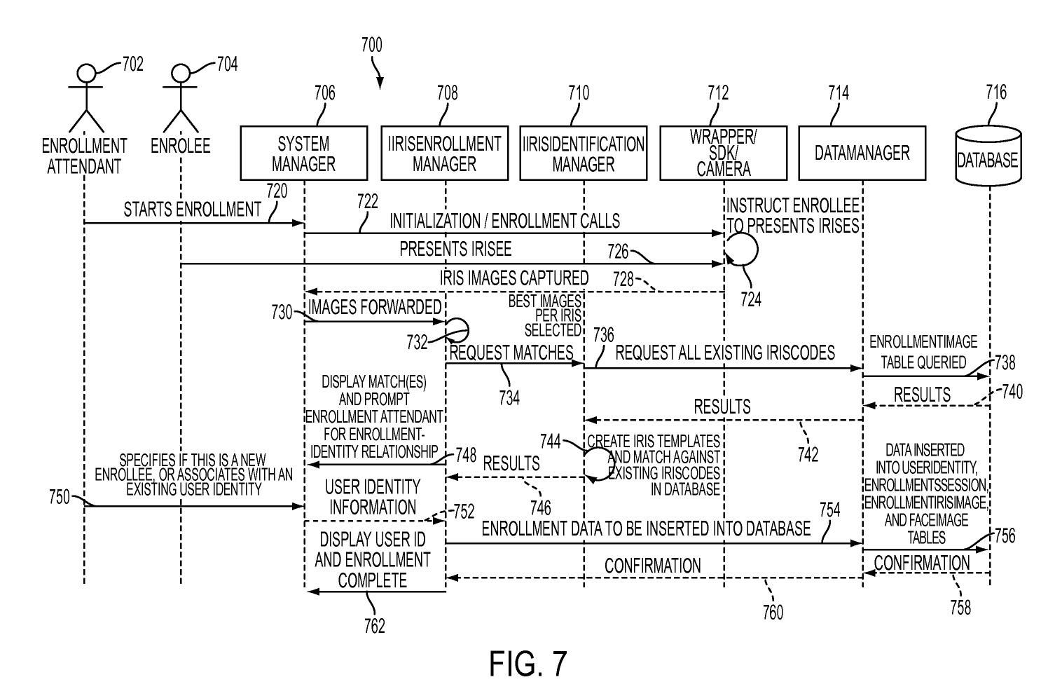

An example enrollment of a user with a mobile device into an identification system having a database such as the database of FIG. 6 is described with reference to FIG. 7. FIG. 7 is a call flow diagram illustrating enrollment of an enrollee through a mobile device according to one embodiment of the disclosure. At call 720 an enrollment attendant 702 begins the enrollment process by accessing the system manager 706. The system manager 706 may be accessed remotely through, for example, a handheld device. At call 722 the identification manager indicates to the camera 712 to initialize an enrollment process. According to one embodiment, instructions to the camera may be interpreted through an interface such as a SDK or wrapper. The camera 712 responds to the enrollment attendant 702 to instruct an enrollee 704 to present their iris to the camera 712. At call 726 the enrollee 704 presents their irises to the camera 712. At call 728 the camera 712 captures the enrollee's 704 irises and forwards the iris images to the system manager 706. The system manager 706 forwards the iris images to an IIrisEnrollment Manager 708 at call 730, which selects certain images of the forwarded iris images at call 732. For example, the IIrisEnrollment Manager 708 may select the best images according to a hamming distance or a score for each iris image. At call 734 the IIrisEnrollment Manager 708 requests matches for the images selected at call 732. At call 736 the IIrisIdentification Manager 710 requests all existing IrisCodes from the data manager 714. The data manager 714 queries a database 716, such as the database of FIG. 6, at call 738.

The database 716 returns results to the data manager 714 at call 740, which returns results to the IIrisIdentification manager 710 at call 742. For each of the results, iris templates are created and matched against IrisCodes already present in the database at call 744. Results from the matches are returned to the IIrisEnrollment manager 708 at call 746. At call 748 matches are presented to the enrollment attendant 702 along with a prompt for entry of an enrollment-identity relationship through the system manager 706. At call 750 the enrollment attendant 702 indicates if the enrollee 704 is a new enrollee or indicates an existing user identity to which the iris images are associated. At call 752 the system manager 706 forwards the user identity information to the IIrisEnrollment manager 708, which forwards, at call 754, the information to the data manager 714 for entry to the database 716. At call 756 the data manager 714 inserts information about the enrollee 704 into the database 716. For example, the data manager 714 may access UserIdentity, EnrollmentSession, EnrollmentIrisImage, and FaceImage tables of the database illustrated in FIG. 6. The database 716 returns a confirmation at call 758, which the data manager 714 forwards to the IIrisEnrollment manager 708 at call 760. The IIrisEnrollment manager 708 displays the user ID and a message indicating completion of enrollment to the system manager 706 at call 762.

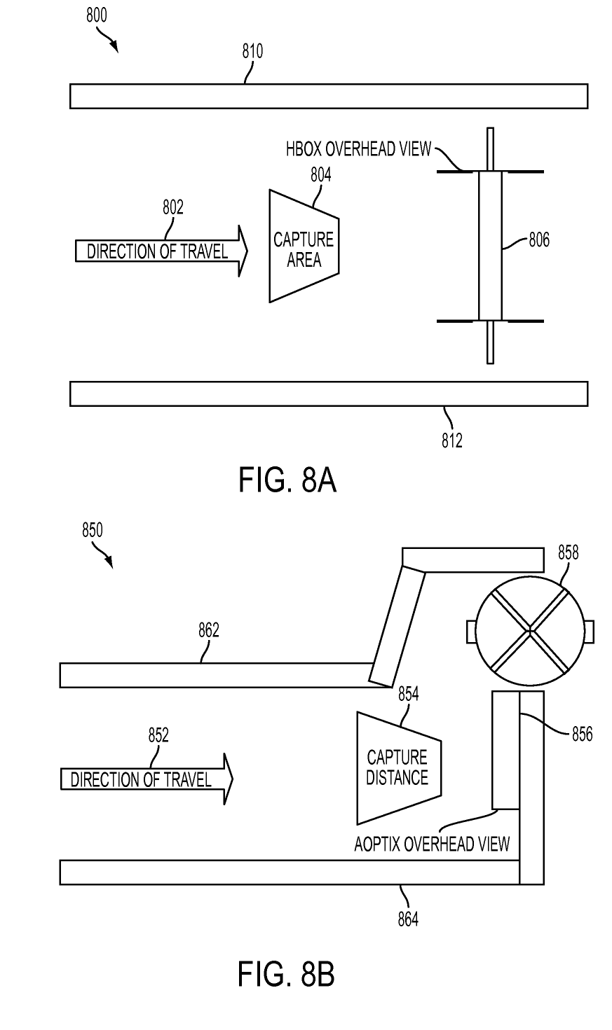

A user may also be enrolled in an identification system by walking through a pedestrian lane. Pedestrian lanes configured for use with an identification system are illustrated in FIGS. 8A and 8B. FIG. 8A is an overhead view for a pedestrian lane in a walk-through configuration according to one embodiment of the disclosure. A pedestrian lane 800 may be bounded by walls or gates 810, 812. Pedestrians may follow a direction 802 of travel through a capture area 804. Inside of the capture area an iris scanner 806 captures iris images of pedestrians passing through the pedestrian lane 800.

In another embodiment, a pedestrian lane may be configured in a stop-and-go configuration. FIG. 8B is an overhead view for a pedestrian lane in a stop-and-go configuration according to one embodiment of the disclosure. A pedestrian lane 850 may be bounded by walls or gates 862, 864. Pedestrians may follow a direction 852 of travel to a capture area 854. An individual may be instructed to stop in the capture area 854 to allow an iris scanner 856 to capture iris images of the individual After iris images are captured by the scanner 856 the user is instructed to proceed through a gate 858. If the pedestrian lane 850 is operating in an authentication mode the gate 858 may be opened or closed based on a result of the authentication process. That is, if the iris images match an authorized user the gate 858 may open, otherwise the gate 858 may remain closed to allow security attendants to further attend to the individual.

The pedestrian lanes of FIGS. 8A and 8B may be configured to operate in enrollment mode or identification mode. During enrollment mode, iris images captured are enrolled in the identification system. During identification mode, iris images captured are matched against previously enrolled iris images in the identification system.

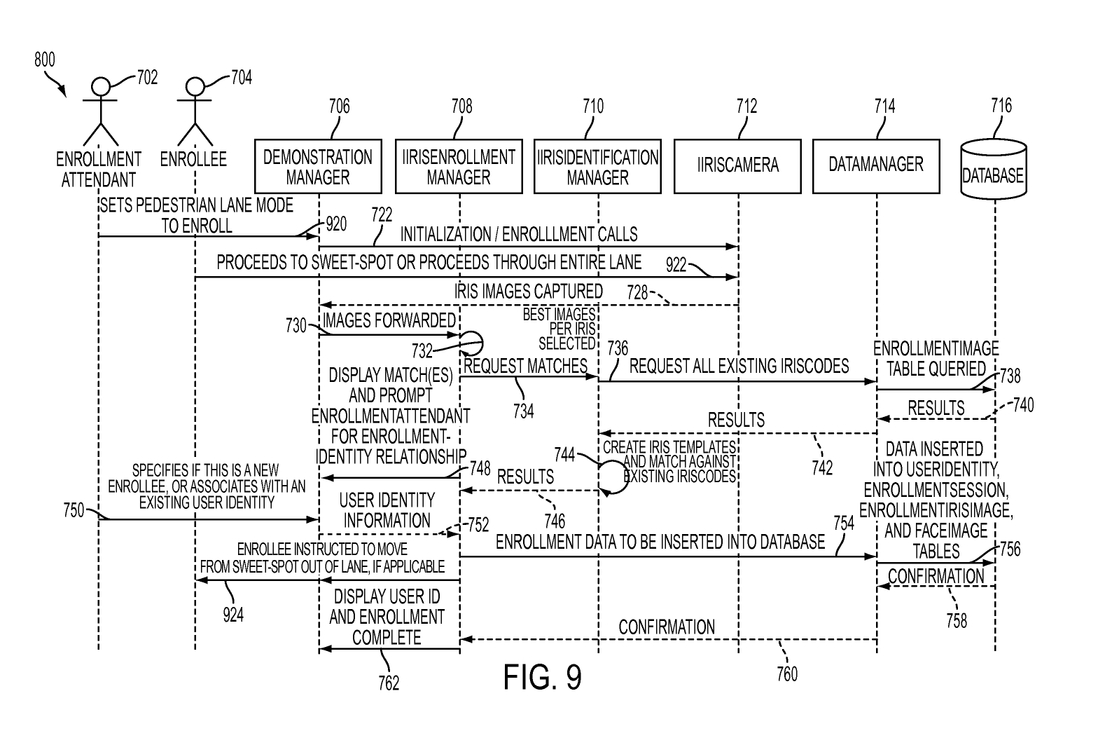

Operation of an identification system during enrollment mode using a pedestrian lane may be similar to operation during enrollment with a mobile device. FIG. 9 is a call flow diagram illustrating enrollment of an enrollee through a pedestrian lane according to one embodiment of the disclosure. At call 920 the enrollment attendant 702 sets a pedestrian lane to enrollment mode. After initialization at call 722, the enrollee 704 proceeds, at call 922, to walk through the pedestrian lane or to walk to a capture zone and temporarily stand still at call 724. After the enrollment process completes, the enrollment attendant 702 may instruct the enrollee 704 to leave the capture zone at call 924 if the pedestrian lane is operating in a stop-and-go configuration.

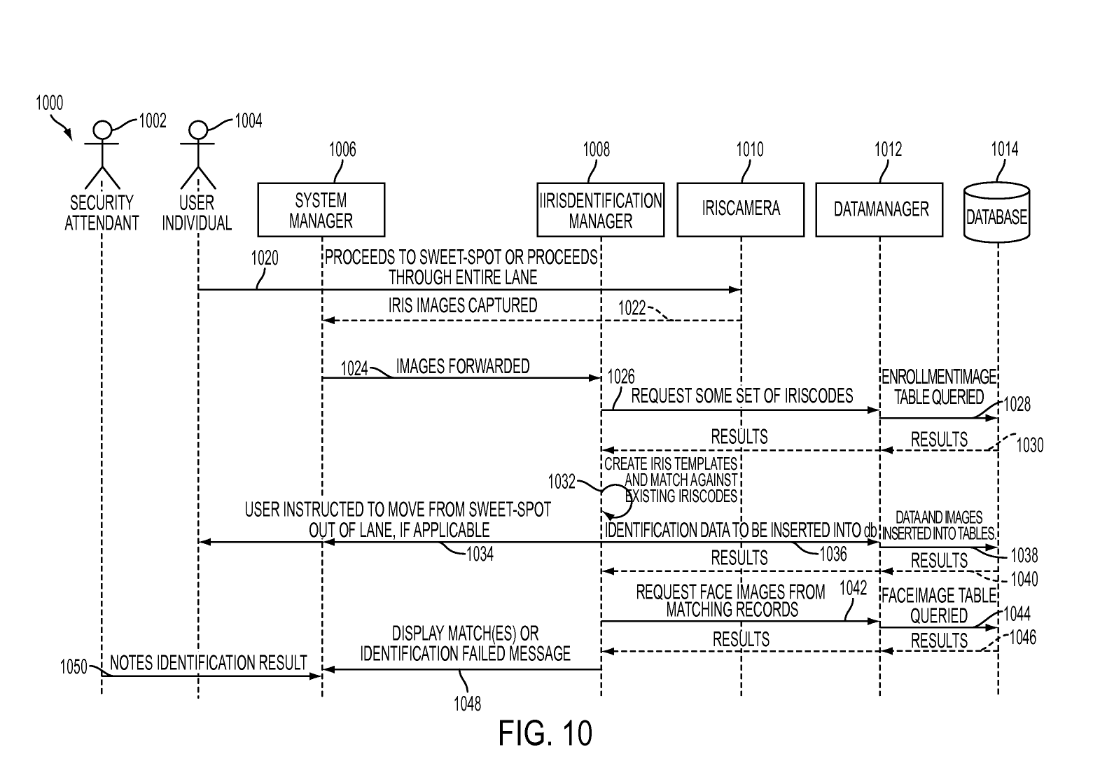

After enrollment of individuals in an identification system, pedestrian lanes may be operated in identification mode. For example, a pedestrian lane located at a border crossing of a country may be configured to identify authenticated individuals for entry into the country. FIG. 10 is a call diagram illustrating identification of an individual with an identification system according to one embodiment of the disclosure. A call flow 1000 begins with a call 1020 during which an individual 1004 proceeds through a pedestrian lane into a capture zone for an IIris camera 1010. The camera 1010 captures iris images at call 1022 and returns the iris images to a system manager 1006. At call 1024 the iris images are forwarded to an IIrisIdentification manager 1008. At call 1026 the IIrisIdentification manager 1008 requests a set of IrisCodes from the data manager 1012. At call 1028 the data manager 1012 queries a database 1014, such as the database of FIG. 6.

The database 1014 returns the results at call 1030, which are forwarded from the data manager 1012 to the IIrisIdentification manager 1008. At call 1032 the IIrisIdentification manager 1008 creates iris templates and matches the templates against existing IrisCodes. If the pedestrian lane is operated in a stop-and-go configuration, the individual 1004 may be instructed to continue moving at call 1034. Identification data is transmitted to the data manager 1012 at call 1036 for insertion into the database 1014 at call 1038. Results are returned to the data manager 1012 and the IIrisIdentification manager 1008 at call 1040. The IIrisIdentification manager 1008 requests face images matching the iris image from the database 1014 through the data manager 1012 at calls 1042 and 1044. Results, including a pass or fail authorization and a face image, may be returned to the system manager 1006 and displayed to a security attendant 1002 at call 1048. The security attendant 1002 may take an appropriate action based on the notification result at call 1050. According to one embodiment, a command center may be coupled to each of the pedestrian lanes for displaying feedback to remotely located attendants.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
capturing at least one enrollment iris image of an individual with an iris camera;
enrolling the individual in an identification system;
capturing at least one identification iris image of the individual with the iris scanner; and
identifying the individual by comparing the at least one identification iris image with the at least one enrollment iris image in the identification system.

2. The method of claim 1, in which capturing at least one enrollment iris image comprises capturing at least two iris images for each of a left eye and a right eye of the individual.

3. The method of claim 2, further comprising selecting at least two iris images for each of the left eye and the right eye of the individual according to at least one of a N-to-N enrollment manager, a non-filtering enrollment manager, and a score rank enrollment manager.

4. The method of claim 1, further comprising capturing biographical data having at least one of a height, weight, eye color, hair color, and a face image before enrolling the individual in the identification system.

5. The method of claim 1, in which enrolling the individual in the identification system comprises:
comparing iris images already enrolled in the identification system to the at least one enrollment iris image;
when a match is found to an already enrolled iris image, updating the identification system with the at least one enrollment iris image; and
when no match is found to an already enrolled iris image, enrolling the individual as a new user to the identification system.

6. The method of claim 1, in which capturing the at least one enrollment iris image comprises capturing the at least one enrollment iris image with at least one of a mobile device and a pedestrian lane.

7. The method of claim 1, further comprising authenticating the individual when the at least one identification iris image matches the at least one enrollment iris image.

8. The method of claim 7, further comprising displaying biographical data on a display screen when the at least one identification iris image does not match the at least one enrollment iris image.

9. The method of claim 7, in which authenticating the individual comprises allowing entry across a border.

10. A computer program product, comprising:
a computer-readable medium comprising:
code to receive at least one enrollment iris image for an individual;
code to enroll an individual by storing the at least one enrollment iris image in an identification database having a plurality of stored iris images;
code to receive an identification iris image from an iris scanner;
code to compare the identification iris image to the plurality of stored iris images;
code to display an authorized user message to an attendant when the identification iris image matches one of the plurality of stored iris images; and
code to display a failed authentication message to an attendant when the identification iris image does not match at least one of the plurality of stored iris images.

11. The computer program product of claim 10, in which the code to enroll the individual comprises code to store biographical data comprising at least one of height, weight, eye color, hair color, and a face image.

12. The computer program product of claim 10, in which the code to receive the at least one enrollment iris image for the individual comprises code to communicate with an iris camera through an interface.

13. The computer program product of claim 10, in which the code to enroll the individual comprises:
code for comparing the at least one enrollment iris image to the plurality of stored iris images; and
updating the plurality of stored iris images in the identification database when the at least one enrollment iris image matches one of the plurality of stored iris images.

14. The computer program product of claim 10, further comprising code to select a subset of the at least one enrollment iris images for enrolling in the identification database according to at least one of a N-to-N comparison algorithm, a non-filtering comparison, and a score ranking algorithm.

15. The computer program product of claim 10, in which the code to display an authorization message comprises code to display authorization to cross a country border.

16. An apparatus, comprising:
at least one processor and a memory device coupled to the at least one processor, in which the at least one processor is configured:
to receive at least one enrollment iris image for an individual;
to enroll an individual by storing the at least one enrollment iris image in an identification database having a plurality of stored iris images;
to receive an identification iris image from an iris scanner;
to compare the identification iris image to the plurality of stored iris images;
to display an authorized user message to an attendant when the identification iris image matches one of the plurality of stored iris images; and
to display a failed authentication message to an attendant when the identification iris image does not match at least one of the plurality of stored iris images.

17. The apparatus of claim 16, in which the at least one processor is further configured to store biographical data comprising at least one of height, weight, eye color, hair color, and a face image in the identification database.

18. The apparatus of claim 16, in which the at least one processor is further configured to communicate with an iris camera through an interface.

19. The apparatus of claim 16, in which the at least at least one processor is further configured to:
compare the at least one enrollment iris image to the plurality of stored iris images; and
update the plurality of stored iris images in the identification database when the at least one enrollment iris image matches one of the plurality of stored iris images.

20. The apparatus of claim 15, in which the at least one processor is further configured to select a subset of the at least one enrollment iris images for enrolling in the identification database according to at least one of a N-to-N comparison algorithm, a non-filtering comparison, and a score ranking algorithm.
